(19) United States
(12) Patent Application Publication
(10) Pub. No.: US 2008/0175361 A1
(43) Pub. Date: Jul. 24, 2008

(54) Apparatus and method for coextensive operation of multiple broadband services on a local network

(75) Inventor: Louis Mamakos, Holmdel, NJ (US)

Correspondence Address: ALAN KALB, VP LAW;VONAGE, 23 MAIN STREET, HOLMDEL, NJ, 07733, US

(73) Assignee: VONAGE NETWORK, Holmdel, NJ (US)

(21) Appl. No.: 11/655,142

(22) Filed: Jan. 19, 2007

(51) Int. Cl. H04M 11/00

(52) U.S. Cl. 379/93.06

(57) ABSTRACT

Apparatus for converting a local POTS network to VoIP capability includes a signal controller that is adapted for connection between a broadband-enhanced POTS service point and the local network for reducing POTS signaling. The apparatus is, for example, a high pass filter that includes a first port for receiving broadband-enhanced POTS service and a second port for sending DSL signals to the local network. The high pass filter can be connected to broadband-enhanced POTS service at a Network Interface Unit of a DSL subscriber location. Preferably, the high pass filter has a frequency response range that is capable of greatly reducing or eliminating a POTS service loop voltage and/or baseband voice signals on the local network.

### FIELD OF THE INVENTION

The invention is related to the field of telecommunication devices and services and more specifically, the invention is directed to an apparatus for enabling Voice over IP (VoIP) services on existing subscriber location Plain Old Telephone Service (POTS) wiring/networks.

### BACKGROUND OF THE INVENTION

Present day telephony voice networks were built around circuit switches, end offices, a toll network, tandem switches, and twisted pair wires. These voice networks are referred to as a Public Switched Telephone Network (PSTN) or Plain Old Telephone Service (POTS). Due to bandwidth limitations of POTS, there is an inherent inability to efficiently integrate multiple types of media such as telephony, data communications (including video) for Personal Computers (PC), and Television (TV) broadcasts. As such, broadband technology and architectures were developed that could be adapted to the POTS infrastructure. This technology included Asymmetrical Digital Subscriber Line (ADSL) communication networks where voice signals were transmitted in a lower frequency range of the POTS frequency baseband and data signals were transmitted in a higher frequency range.

Voice over IP (VoIP) is a recent technological development in the field of telecommunications that is utilized to transmit voice over a data network using the Internet Protocol (IP). IP is a part of the Transmission Control Protocol/Internet Protocol (TCP/IP) family of protocols described in software that tracks the Internet address of nodes, routes outgoing messages, and recognizes incoming messages. Such a data network may be the Internet or a corporate intranet, or any other TCP/IP network. Subscribers (either businesses or individuals) use VoIP over DSL (i.e., over the old POTS lines) by purchasing and installing the necessary equipment to access a VoIP service provider at their DSL-equipped location. Such VoIP equipment would include, in one example, an adapter connected between the subscriber's PSTN phone and a DSL modem to convert voice data to/from analog/digital format. Voice data is subsequently passed from the DSL modem to an IP network via a PSTN gateway.

FIG. 1 depicts a system level block diagram of a typical VoIP via DSL subscriber location. Specifically, the subscriber location 100 (e.g., a residence) includes a Network Interface Unit (NIU) 102 which receives POTS/DSL service from a local provider (via a service loop 118) and distributes such service into the subscriber location 100 via a distribution line 104 (ordinary telephone wiring). POTS is provided to subscriber telephone equipment 106 from distribution line 104 via a low pass filter (LPF) 108 that filters out the high frequency DSL component of the incoming signal from the local provider. A DSL modem 110 connected to the distribution line 104 provides broadband service to one or more subscriber devices such as a personal computer 112. Additionally, an adapter 114 is connected to the modem 110. The adapter 114 converts digital signaling from the DSL service to analog signaling to provide VoIP to another subscriber device (e.g., phone 106) via line 116.

Based on this description, it is understandable that when a new VoIP subscriber establishes service, some manner of rewiring must be performed in order to connect the VoIP equipment to the DSL service. For example, new/additional lines 116 would have to be run from the location of the modem 110/adapter 114 to any and all telephones that the customer would want to have for VoIP service. In the alternative, the subscriber would have to pay for cordless equipment in each instance where the VoIP service was preferred throughout the location. One solution to this rewiring problem and the attendant expense is to use the existing telephone wiring/network at the subscriber's location. However, this solution requires the subscriber to access the NIU and perform a number of rewiring operations that may confuse someone who is not familiar with basic telephone wiring. One such rewiring operation requires the use of a second pair of telephone wiring be connected between the POTS/DSL service and the DSL modem to take advantage of the previously wired “network” existing in the residence. If the rewiring operations are not correctly performed, permanent damage can occur to the VoIP equipment. If such rewiring operations were correctly performed, the rewiring operation could accidentally be reversed by others who have access to the NIU (e.g., a technician of the local POTS service).

Therefore, there is a need in the art for an apparatus and method for enabling simultaneous operation of VoIP and DSL services on existing telephone wiring/networks at a subscriber location that mitigates the aforementioned problems of additional equipment/wiring costs and/or rewiring errors.

### SUMMARY OF THE INVENTION

The present invention generally relates to an apparatus for converting a local POTS network to VoIP capability. The apparatus includes a signal controller that is adapted for connection between a broadband-enhanced POTS service point and the local network for reducing POTS signaling. In one embodiment of the invention, the apparatus is a high pass filter. Such high pass filter includes a first port for receiving broadband-enhanced POTS service and a second port for sending DSL signals to the local network. The high pass filter is connected to broadband-enhanced POTS service at a Network Interface Unit of a DSL subscriber location. Preferably, the high pass filter has a frequency response of approximately 15 KHz-5 MHz or other such frequency response ranges that are capable of greatly reducing or eliminating a POTS service loop voltage and/or baseband voice signals on the local network and isolating the service loop from the local VoIP telephony voltages and signals.

### BRIEF DESCRIPTION OF THE FIGURES

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a block diagram of a prior art VoIP via DSL system at a subscriber location;

FIG. 2 depicts a block diagram of a VoIP via DSL system at a subscriber location in accordance with the subject invention;

FIG. 3 is a schematic diagram of a controller that may be used to practice the present invention; and

FIG. 4 is a graph of the frequency response characteristics of the controller in one embodiment of the subject invention.

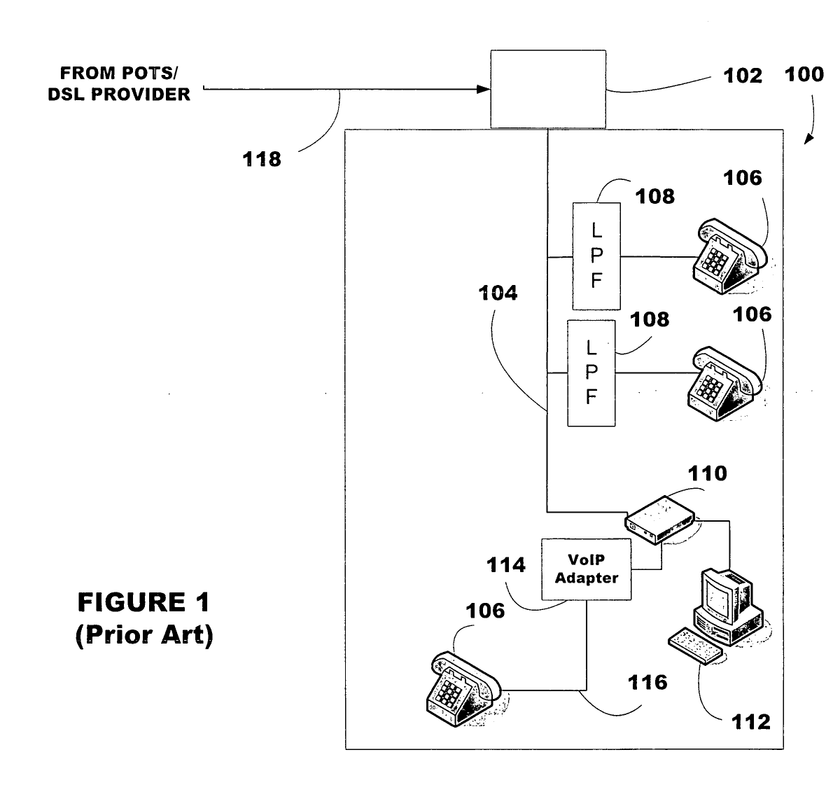

To facilitate understanding, identical reference numerals have been used, where possible, to designate identical elements that are common to the figures.

### DETAILED DESCRIPTION

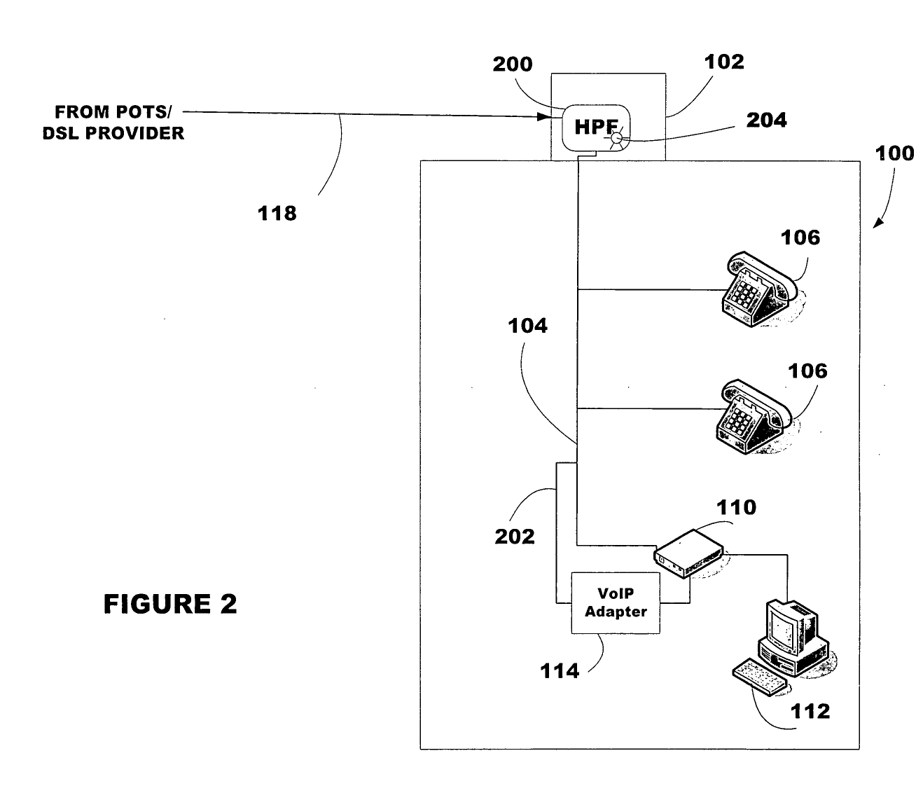

To achieve the desired objectives, the subject invention provides for an apparatus that provides for the coextensive operation of different broadband services or features on the same physical medium that makes up a local network. This apparatus avoids the need to perform complex or additional wiring operations by taking advantage of the existing physical wiring of which the local network is comprised. In a preferred embodiment of the invention, shown in FIG. 2, the apparatus is shown as part of and operating with an existing consumer level communications network (i.e., existing POTS wiring, phones and modems) to provide VoIP and DSL without additional and/or substantial reconfiguring or wiring being necessary although other applications are contemplated and considered within the scope of the invention.

FIG. 2 depicts a system level block diagram of a VoIP via DSL system at a subscriber location 100 in accordance with the subject invention. Specifically, the subscriber location or local network 100 (e.g., a residence) introduced earlier in the specification includes a Network Interface Unit (NIU) 102 which receives POTS/DSL service from a local provider (e.g, via a Central Office not shown and service loop 118). A signal controller 200 is connected between the POTS/DSL service provider entry point into the NIU 102 and the local network 100. By virtue of the characteristics of the signal controller 200, only the DSL component of the POTS/DSL service passes into the local network 100 via the distribution line 104. In one embodiment of the invention, the distribution line 104 is at least one twisted pair of ordinary telephone wiring. A DSL modem 110 connected to the distribution line 104 provides a first broadband service (i.e., the DSL service) to at least one first local network end-user device such as a personal computer 112. Other first local network end-user devices may also be part of the local network such as but not limited to laptop computers, routers, printers (dedicated or “all-in-one” type devices), wireless devices and the like that are not shown in FIG. 2 for sake of clarity, but are considered optional local network components. Additionally, the modem 110 is connected to an adapter 114 to provide a second broadband service (i.e., VoIP) to at least one second local network end-user device 106 via lines 202 and 104. In one embodiment of the invention, the at least one second local network end-user device 106 is a POTS type telephone.

The apparatus and overall system described above provides VoIP service to any and all second local network end-user devices (e.g., telephones) that the customer would want by connecting an interface line 202 of the adapter 114 to the existing local network 100 (i.e., the existing twisted pair telephone wiring) at the distribution line 104. In greater detail, the signal controller 200 reduces or completely eliminates the DC loop voltage and baseband voice signals that comprise the POTS portion of the POTS/DSL service provided to the local network 100. As such, the second local network end-user devices 106 are essentially cut off from the existing POTS signaling and network (the characteristics and frequency response of the controller 200 are explained in greater detail below). Since the adapter 114 converts digital signals (e.g., from the DSL service carrying Internet Protocol (IP) signaling) to/from analog signals that drive ordinary POTS type telephones, the second local network end-user devices 106 can now only “see” signaling from the adapter 114 which becomes a new foreign exchange station for the second local network end-user devices 106. That is, the analog signals from the second local network end-user devices 106 travel along the existing network distribution line 104 to interface line 202 and back to the adapter 114 and vice versa. The adapter 114 then passes digital signals back to the DSL service (and an external network, not shown) via the modem 110. Accordingly, multiple broadband services (DSL and VoIP in the discussed example) are sharing a portion of the same physical medium (distribution line 104).

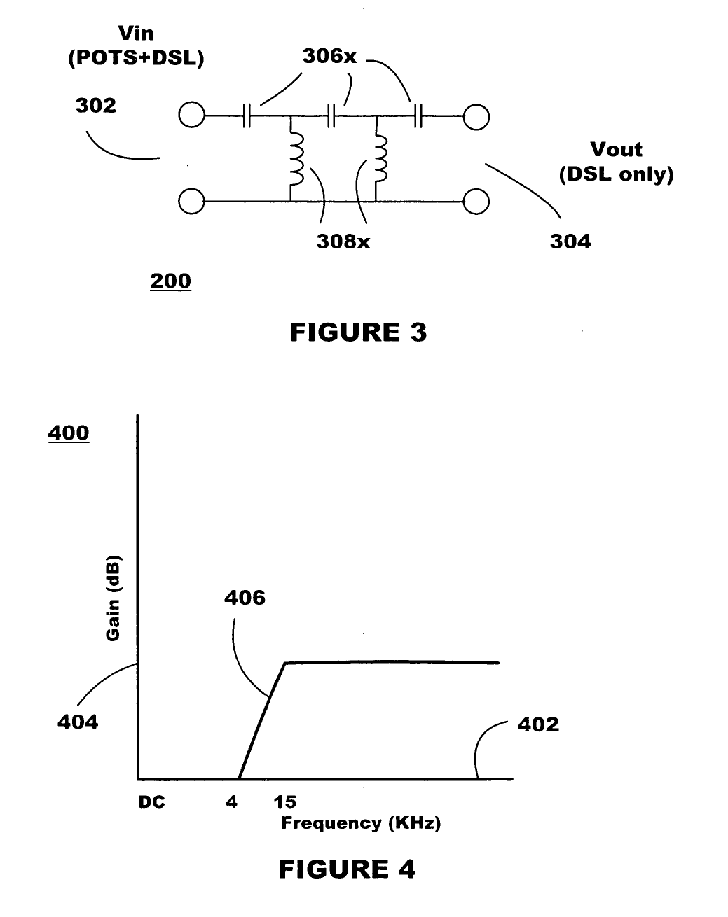

FIG. 3 is a schematic diagram of a signal controller 200 that may be used to practice the present invention. Specifically, in one embodiment of the invention, the VoIP/DSL signal controller 200 is a high pass filter (HPF). HPFs can come in a variety of configurations and any and all such embodiments are within the scope of the subject invention. The HPF depicted in FIG. 3 is recognizable to those skilled in the art as a Chebyshev filter and is provided and described only by means of non-limiting example. In detail, the controller (HPF) 200 comprises an input port 302 to which the POTS/DSL combined signal is connected. Through a plurality of active and/or passive circuit elements such as capacitors 306x and inductors 308x, the POTS/DSL combined signal is filtered to attenuate the low frequency (POTS) component. One skilled in the art is capable of determining suitable values for the passive circuit elements to provide the desired frequency response characteristics (described below).

Only the high frequency DSL component of the originally inputted signal is seen at an output port 304 of the controller and on the distribution line 104. As a result, the original subscriber POTS equipment 106 is effectively disconnected from the POTS network and service without having to physically disconnect the actual distribution line 104 that previously provided the POTS service. The benefit realized is that all of the existing phone lines in the residence now can be used for VoIP service without the need for rewiring the NIU or internal residential telephone lines or adding new lines downstream of the VoIP adapter 114. These same lines also still carry the DSL signals; therefore, multiple broadband services can exist on the subscriber's POTS network. A further advantage is recognized by virtue of the characteristics of the signal controller 200. Specifically, high impedance characteristics are present at both the input port 302 and the output port 304 for DC and low frequency telephony signals. As such, the adapter 114 does not “electrically see” the impedance load inherent in the service loop 118 running from the NIU 102 to the Central Office (or switch therebetween); therefore, there are no power losses or loading in the network caused by trying to drive such a long conductor from a relatively small power supply (adapter 114).

As a precautionary measure, the controller 200 is equipped with a voltage detection/alarm feature 204 (see FIG. 2) to guard against network component damage. Specifically, the detection/alarm feature 204 is placed at the output port 304 of the controller 200 to alert a network user (i.e., DSL subscriber, homeowner, telecom service provider technician or the like) that a DC loop voltage from the POTS has been detected and is entering the network. Such alert will allow the network user the opportunity to disconnect the POTS/DSL service from the network to prevent damage to VoIP equipment or other such DC loop voltage sensitive devices. In one embodiment, the detection/alarm feature 204 is a light emitting diode (LED) placed in a visible location on the controller 200 so that a network user can easily and quickly detect DC loop voltage conditions when installing or subsequently monitoring the controller 200 or NIU 102. Other types of detection/alarm embodiments are considered within the scope of the invention and may be, but not limited to other visible alarm besides LEDs, audible alarms, remote detection and paging services/applications and the like.

In greater detail with regard to one embodiment of the subject invention, it is well known that typical POTS processes voice signals in a bandwidth of approximately 400-3,400 Hz. All frequencies below 400 Hz (including the DC loop voltage that energizes a basic telephone circuit) and above 3,400 hertz are attenuated. FIG. 4 depicts a graph 400 of the frequency response of a HPF suitable for use in the subject invention. Specifically, the x-axis 402 of the graph 400 plots the desired frequency range for the invention and the y-axis 404 plots the gain of the HPF over the desired frequency range. In a preferred embodiment of the invention, the frequency response of the HPF is shown by curve 406 as blocking all low frequencies (and DC signals) below approximately 4 KHz and ramping up to 0 dB attenuation at approximately 15 KHz.

While foregoing is directed to embodiments of the present invention, other and further embodiments of the invention may be devised without departing from the basic scope thereof, and the scope thereof.

1. An apparatus for converting a local Plain Old Telephony Service (POTS) network to VoIP capability comprising:
a signal controller adapted for connection between a broadband-enhanced POTS service point and the local POTS network for reducing POTS signaling;
and a POTS signaling detection device connected to the signal controller.

2. The apparatus of claim 1 wherein the signal controller is a high pass filter.

3. The apparatus of claim 2 wherein the high pass filter further comprises a first port for receiving broadband-enhanced POTS service and a second port for sending DSL signals to the local network.

4. The apparatus of claim 2 wherein the high pass filter is connected to the broadband-enhanced POTS service at a Network Interface Unit of a DSL subscriber location.

5. The apparatus of claim 2 wherein the high pass filter has a frequency response of approximately 15 KHz-5 MHz.

6. The apparatus of claim 2 wherein the high pass filter eliminates POTS service loop voltage on the local network.

7. The apparatus of claim 2 wherein the high pass filter eliminates POTS service baseband voice signals on the local network.

8. The apparatus of claim 1 wherein the broadband-enhanced POTS service point is a Network Interface Unit of premises receiving the broadband-enhanced POTS.

9. A system for coextensive operation of multiple broadband services on a local network comprising:
at least one first local network end-user device adapted to use a first broadband service and at least one second local network end-user device adapted to use a second broadband service, the at least one first local network end-user device and at least one second local network end-user device defining the local network; and
a signal controller adapted for connection between a broadband service provider entry port into the local network and the at least one first and second local network end-user devices such that the first and second broadband services share the same physical medium for communicating with the at least one first and second local network end-user devices.

10. The system of claim 9 wherein signal controller is a high pass filter.

11. The system of claim 10 wherein the high pass filter further comprises a first port for receiving broadband-enhanced POTS service and a second port for sending DSL signals to the local network.

12. The system of claim 10 wherein the high pass filter is connected to the broadband-enhanced POTS service at a Network Interface Unit of a DSL subscriber location.

13. The system of claim 10 wherein the high pass filter has a frequency response of approximately 15 KHz-5 MHz.

14. The system of claim 10 wherein the high pass filter eliminates POTS service loop voltage on the local network.

15. The system of claim 10 wherein the high pass filter eliminates POTS service baseband voice signals on the local network.

16. The apparatus of claim 9 wherein the broadband-enhanced POTS service point is a Network Interface Unit of premises receiving the broadband-enhanced POTS.

17. The apparatus of claim 9 wherein the system further comprises a POTS signaling detection device connected to the signal controller.

18. A method for coextensive operation of multiple broadband services on a local network, the local network having at least one first local network end-user device adapted to use a first broadband service and at least one second local network end-user device adapted to use a second broadband service, the method comprising:
opening a connection between a broadband service provider entry port into the local network and the at least one first and at least one second local network end-user devices;
connecting a signal controller adapted for connection at said opened connection, the signal controller having response characteristics that provide sharing of the same physical medium for the first and second broadband services for communicating with the at least one first and second local network end-user devices.
